(19) United States
(12) Patent Application Publication
(10) Pub. No.: US 2026/0285164 A1
(43) Pub. Date: Sep. 24, 2026

(54) APPARATUS AND METHOD FOR CONTROLLING REGENERATIVE BRAKING

(71) Applicants: Hyundai Motor Company, Seoul (KR); Kia Corporation, Seoul (KR)

(72) Inventors: Jung Ro Yoon, Hwaseong-si (KR); Doo Hee Han, Hwaseong-si (KR); Seong Jae Yoo, Hwaseong-si (KR); Keun Sang Kim, Hwaseong-si (KR); Young Suk Jung, Hwaseong-si (KR); Sung Hyun Cho, Hwaseong-si (KR)

(73) Assignees: Hyundai Motor Company, Seoul (KR); Kia Corporation, Seoul (KR)

(21) Appl. No.: 19/377,750

(22) Filed: Nov. 3, 2025

(30) Foreign Application Priority Data
Mar. 24, 2025 (KR) 10-2025-0037082

(51) Int. Cl. B60L 7/18

(52) U.S. Cl. CPC B60L 7/18; B60L 2240/12; B60L 2260/42

(57) ABSTRACT

In a system and a method for controlling regenerative braking configured for maximizing vehicle energy efficiency by allowing an electrified vehicle to change a maximum regenerative braking allowance used for braking force distribution and regenerative braking control in the electrified vehicle, the method includes analyzing a driver's vehicle speed pattern based on data on a vehicle speed of a vehicle to obtain information on an energy efficiency according to a change in a maximum regenerative braking allowance, determining the maximum regenerative braking allowance in which the driver's vehicle speed pattern is considered based on the obtained information on the energy efficiency according to the change in the maximum regenerative braking allowance, and updating the previous maximum regenerative braking allowance.

### CROSS-REFERENCE TO RELATED APPLICATION

The present application claims, under 35 U.S.C. § 119 (a), the benefit of and priority to Korean Patent Application No. 10-2025-0037082, filed on Mar. 24, 2025, the entire contents of which are incorporated herein by reference.

### BACKGROUND

### Technical Field

The present disclosure relates to a system and a method for controlling regenerative braking of a motor-driven electrified vehicle.

### Background Art

As is well known, hybrid electric vehicles (HEV), battery electric vehicles (BEV), fuel cell electric vehicles (FCEV) and extended-range electric vehicles (EREV) are motor-driven electrified vehicles, which are widely known as electric vehicles (xEV).

The above-mentioned vehicles are driven by electric driving force, that is, driving force by a motor, in which a battery is connected to the motor via an inverter for charging and discharging, and the motor is supplied with power from the battery.

In such an electrified vehicle, regenerative braking by the motor may be performed. In other words, it is possible to charge the battery by recovering kinetic energy of the vehicle as electrical energy through power generation of the motor connected to driving wheels during braking or coasting.

In the regenerative braking, since the battery is charged with the electrical energy generated by the motor, fuel economy (i.e., energy efficiency) of the vehicle may be improved, and thus, the regenerative braking is essential for increasing the efficiency and fuel economy of the vehicle in such a motor-driven vehicle.

In the electrified vehicle, in addition to the regenerative braking, friction braking is performed according to a driver's brake operation, as in other vehicles. Accordingly, the regenerative braking and the friction braking may be performed together during braking, and thus, braking force distribution is performed according to the brake operation.

In other words, in a case where a target braking force, which is a driver's desired braking force, is calculated based on a brake signal corresponding to a driver's brake operation (driver's brake input), for example, a signal from a brake pedal position sensor (BPS) according to a brake pedal operation, distribution of a regenerative braking force and a friction braking force (hydraulic braking force) is performed to satisfy the target braking force.

Furthermore, in a case where the regenerative braking force and friction braking force applied to wheels are determined through the braking force distribution, motor regenerative braking control and friction braking control are performed to generate the respective distributed braking forces.

In a vehicle in which the regenerative braking is performed, a maximum regenerative braking allowance refers to a maximum regenerative braking force which may be achieved by the regenerative braking, and may be expressed as a deceleration (g). Since the regenerative braking force is limited by the maximum regenerative braking allowance set in the vehicle in a case where the regenerative braking force and the friction braking force are distributed in the vehicle, the regenerative braking force of the vehicle as well as the friction braking force may vary depending on the maximum regenerative braking allowance.

For example, since the greater the maximum regenerative braking allowance set in the vehicle, the greater the regenerative braking force generated, it is possible to reduce the friction braking force and the frequency of the friction braking, and to increase the electrical energy which may be recovered by the battery.

However, in the related art, in a case where the maximum regenerative braking allowance is set at a vehicle development stage, the value is applied to the vehicle as it is after mass production. Thus, although both advantages and disadvantages of the maximum regenerative braking allowance exist, it is not possible to change the maximum regenerative braking allowance after the vehicle is delivered. Therefore, the maximum regenerative braking allowance fixed at the time of vehicle delivery should be used as it is until the vehicle is scrapped.

The above information included in the background section is only for enhancement of understanding of the background of the disclosure and therefore it may contain information that does not form the related art that is already known in this country to a person of ordinary skill in the art.

### SUMMARY OF THE DISCLOSURE

The present disclosure has been made in an effort to solve the above-described problems associated with related art, and an aspect of the present disclosure is to provide a system and a method for controlling regenerative braking configured for maximizing vehicle energy efficiency by allowing an electrified vehicle to change a maximum regenerative braking allowance used for braking force distribution and regenerative braking control in the electrified vehicle.

The aspect of the present disclosure is not limited to the above-mentioned aspect, and other aspects not mentioned may be clearly understood by those skilled in the art to which the disclosure belongs from the following description.

In one aspect, the present disclosure provides a system that is configured to control regenerative braking including a vehicle speed sensor detecting a vehicle speed of a vehicle, a controller that is configured to control regenerative braking of the vehicle, a communication apparatus that transmits data on the vehicle speed detected by the vehicle speed sensor, and a computer that analyzes a driver's vehicle speed pattern based on the date of the vehicle speed transmitted through the communication apparatus to obtain information on an energy efficiency according to a change in a maximum regenerative braking allowance, is configured to determine the maximum regenerative braking allowance in which the driver's vehicle speed pattern is considered based on the obtained information on the energy efficiency according to the change in the maximum regenerative braking allowance, and transmits a result of the determining to the vehicle, in which the controller is configured to update the maximum regenerative braking allowance for controlling the regenerative braking of the vehicle to the maximum regenerative braking allowance received from the computer.

In, an exemplary embodiment of the present disclosure, the computer may find an energy efficiency saturation point at which the energy efficiency converges on a specific value based on the information on the energy efficiency according to the change in the maximum regenerative braking allowance, and may be configured to determine the maximum regenerative braking allowance corresponding to the energy efficiency saturation point as the maximum regenerative braking allowance in which the driver's vehicle speed pattern is considered.

In another exemplary embodiment of the present disclosure, the computer may be a server disposed outside the vehicle, the server being connected to the vehicle through the communication apparatus wirelessly.

In still another exemplary embodiment of the present disclosure, the computer may be connected to the vehicle through the communication apparatus in a wired manner.

In yet another exemplary embodiment of the present disclosure, the computer may receive the date on the vehicle speed at a specific sampling cycle for a predetermined time period from the vehicle, may newly determine the maximum regenerative braking allowance in which the driver's vehicle speed pattern is considered based on the date of the vehicle speed during the predetermined time period, and may transmit the newly determined maximum regenerative braking allowance to the vehicle.

In still yet another exemplary embodiment of the present disclosure, the predetermined time period may be set as an update cycle of the maximum regenerative braking allowance in the computer, and the computer may repeat a process of determining the maximum regenerative braking allowance in which the driver's vehicle speed pattern is considered based on the date of the vehicle speed received from the vehicle during the update cycle, and may transmit the newly determined maximum regenerative braking allowance to the vehicle at the update cycle.

In a further exemplary embodiment of the present disclosure, the computer may be configured to determine a total energy consumption in an acceleration section and a constant speed driving section from the date of the vehicle speed during the predetermined time period, and a total recovery energy in a deceleration section for each maximum regenerative braking allowance, and may be configured to determine the information on the energy efficiency according to the change in the maximum regenerative braking allowance using information on the total energy consumption and the total recovery energy, and a total travel distance determined from the date of the vehicle speed during the predetermined time period.

In another further exemplary embodiment of the present disclosure, the computer may be configured to determine an instantaneous energy consumption from data on vehicle speeds, vehicle driving resistances, and vehicle weights at a previous sampling point and the next sampling point during acceleration and constant speed driving, and may be configured to determine the total energy consumption by summing the instantaneous energy consumption during the predetermined time period.

In still another further exemplary embodiment of the present disclosure, the computer may be configured to determine an instantaneous recovery energy from data on vehicle speeds, decelerations obtained from the date of the vehicle speed, vehicle driving resistances, and vehicle weights at a previous sampling point and at the next sampling point during deceleration, and may be configured to determine the total recovery energy by summing the instantaneous recovery energy during the predetermined time period.

In yet another further exemplary embodiment of the present disclosure, in determining the instantaneous recovery energy, the computer may change the maximum regenerative braking allowance and may be configured to determine the instantaneous recovery energy for each maximum regenerative braking allowance by the regenerative braking using the changed maximum regenerative braking allowance, may determine, based on determining that the deceleration is equal to or lower than the changed maximum regenerative braking allowance, the instantaneous recovery energy for each maximum regenerative braking allowance using the deceleration, may determine, based on determining that the deceleration is greater than the changed maximum regenerative braking allowance, the instantaneous recovery energy for each maximum regenerative braking allowance using the maximum regenerative braking allowance instead of the deceleration, and may be configured to determine the total recovery energy for each maximum regenerative braking allowance by summing the instantaneous recovery energy determined using the deceleration during the predetermined time period and the instantaneous recovery energy determined using the maximum regenerative braking allowance during the predetermined time period.

In still yet another further exemplary embodiment of the present disclosure, the system may further include an input apparatus which is operated in response to a driver's input to reset the updated maximum regenerative braking allowance to a preset initial value.

In another aspect, the present disclosure provides a method for controlling regenerative braking including transmitting data on a vehicle speed detected by a vehicle speed sensor, by a communication apparatus, obtaining information on an energy efficiency according to a change in a maximum regenerative braking allowance based on the date of the vehicle speed transmitted from a vehicle, by a computer connected to the vehicle through the communication apparatus, determining a maximum regenerative braking allowance in which a driver's vehicle speed pattern is considered based on the obtained information on the energy efficiency according to the change in the maximum regenerative braking allowance, and transmitting the determined maximum regenerative braking allowance to the vehicle, by the computer, and updating the maximum regenerative braking allowance for controlling the regenerative braking of the vehicle to the maximum regenerative braking allowance received from the computer, by a controller disposed in the vehicle.

In, an exemplary embodiment of the present disclosure, the method may further include controlling the regenerative braking of the vehicle using the updated maximum regenerative braking allowance, by the controller.

In another exemplary embodiment of the present disclosure, in the determining of the maximum regenerative braking allowance in which the driver's vehicle speed pattern is considered, the computer may find an energy efficiency saturation point at which the energy efficiency converges on a specific value based on the information on the energy efficiency according to the change in the maximum regenerative braking allowance, and may be configured to determine the maximum regenerative braking allowance corresponding to the energy efficiency saturation point as the maximum regenerative braking allowance in which the driver's vehicle speed pattern is considered.

Other aspects and exemplary embodiments of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are provided hereinbelow by way of illustration only, and thus are not limitative of the present disclosure, and wherein

FIG. 1 is a diagram illustrating a maximum regenerative braking allowance and braking force distribution in a typical electrified vehicle;

FIG. 2 is a diagram showing a configuration of a regenerative braking control system according to an exemplary embodiment of the present disclosure;

FIG. 3 is a diagram schematically showing a state in which OTA update is performed in a vehicle according to an exemplary embodiment of the present disclosure;

FIG. 4, FIG. 5 and FIG. 6 are diagrams showing a statistical analysis result of deceleration according to a driver's driving pattern and an energy efficiency trend according to a maximum regenerative braking allowance in an exemplary embodiment of the present disclosure;

FIG. 7 is a flowchart showing a process of updating a maximum regenerative braking allowance in a method for controlling regenerative braking according to an exemplary embodiment of the present disclosure; and

FIG. 8 is a diagram showing an energy efficiency based on a maximum regenerative braking allowance according to an exemplary embodiment of the present disclosure.

It should be understood that the appended drawings are not necessarily to scale, presenting a somewhat simplified representation of various exemplary features illustrative of the basic principles of the disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Hereinafter, exemplary embodiments of the present disclosure will be described in detail with reference to the accompanying diagrams. Specific structural or functional descriptions presented in the exemplary embodiments of the present disclosure are merely exemplified for describing embodiments according to the concept of the present disclosure, and embodiments according to the concept of the present disclosure may be implemented in various forms. Furthermore, the present disclosure should not be construed as limited to the exemplary embodiments described in the present specification, but should be understood to include all modifications, equivalents, or substitutes included in the concept and technical scope of the present disclosure.

It will be understood that, although the terms “first”, “second”, etc. may be used herein to describe various elements, these elements should not be limited by these terms. These terms are only used to distinguish one element from another. For example, a first element may be termed a second element, and similarly, a second element may be termed a first element, without departing from the scope of the exemplary embodiments of the present disclosure.

Furthermore, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers will be used throughout the diagrams to refer to the same or like parts. The terminology used herein is for describing embodiments only and is not intended to limit exemplary embodiments of the disclosure. As used herein, the singular forms “a” and “an” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

Before describing embodiments of the present disclosure, the problems of the related art will be described.

FIG. 1 is a diagram illustrating a state in which a maximum regenerative braking allowance is set in an electrified vehicle, which shows a maximum regenerative braking allowance ([g]) and a braking force distribution state in coordinates where a horizontal axis represents a brake pedal displacement value (brake pedal position sensor (BPS) value) and a vertical axis represents a braking force.

A braking force line ‘L’ represents a total braking force, which may be a driver's desired braking force according to the brake pedal position sensor (BPS) value. Here, a braking force at a point P becomes the maximum regenerative braking allowance. Even in a case where the brake pedal position sensor value becomes greater than or equal to the point P in a state where the maximum regenerative braking allowance is set, the regenerative braking force is limited to the maximum regenerative braking allowance.

In the instant case, a friction braking force equal to an insufficient braking force is used to reach the total braking force. Here, the friction braking force (“Friction brake”) is divided into a front braking force (“Front axle”) applied to front wheels and a rear braking force (“Rear axle”) applied to rear wheels.

As described above, the maximum regenerative braking force in the vehicle is set to the maximum regenerative braking allowance, and the higher the maximum regenerative braking allowance, the greater the regenerative braking force, which has the advantage of increasing the vehicle's energy efficiency (fuel economy).

Furthermore, since the friction braking force is reduced as the regenerative braking force is increased, it is possible to solve problems caused by a brake disc heat capacity, and to reduce dust caused by friction between a pad and a disc.

On the other hand, the higher the maximum regenerative braking allowance, the greater the regenerative braking force, and thus, the endurance of components such as a motor shaft and bearings decreases in a PE system. Furthermore, the brake disc becomes very rusty due to reduction in use of friction braking, and there is also a disadvantage of increased noise and appearance degradation due to the rust.

In the related art, after the maximum regenerative braking allowance is determined in the vehicle development stage, the value is applied to the mass production vehicle as is and is used as a fixed value even after delivery, and a driver experiences regenerative braking at the fixed value.

Although distributions of decelerations may vary depending on driver's driving tendencies or vehicle features, the advantages and disadvantages may differ depending on vehicles in a case where a maximum regenerative braking allowance which is predetermined in the vehicle development stage is applied to the mass production vehicle without change.

For example, the predetermined maximum regenerative braking allowance may be too large depending on the vehicles, which may result in disc rust or worsening the endurance of the PE system. On the other hand, the predetermined maximum regenerative braking allowance may be too small depending on the vehicles, which may be disadvantageous in terms of energy efficiency.

As described above, in the related art, although the maximum regenerative braking allowance may be too large or too small depending on the vehicles or drivers, causing various problems, it is not possible to change the maximum regenerative braking allowance in mass produced and delivered vehicles. Moreover, it is difficult for the driver to find an optimal value of the maximum regenerative braking allowance suitable for the driver's vehicle.

Furthermore, the maximum regenerative braking allowance which is predetermined in the vehicle development stage may be set too small compared to a driving pattern of the driver after mass production and delivery, so that an actual energy efficiency of the vehicle cannot be maximized, and in the instant case, it is not possible to check the result and change the maximum regenerative braking allowance.

Accordingly, to solve the above-mentioned problems, there are provided an system and a method configured for determining an optimal maximum regenerative braking allowance based on a driver's driving experience during vehicle operation, instead of a value set in a vehicle development stage, and applying the optimal maximum regenerative braking allowance to the vehicle.

Unlike the related art in which an initial value set prior to mass production is applied to a delivered vehicle as a fixed value, according to an exemplary embodiment of the present disclosure, a process of determining an optimal maximum regenerative braking allowance in which an actual driver's driving tendency and driving pattern are considered based on information indicating a driving state of a vehicle, in other words, vehicle driving information, and applying the result to the vehicle to be used for regenerative braking control.

In an exemplary embodiment of the present disclosure, in a case where the driver's driving tendency or driving pattern changes during a recent vehicle operation, or in a case where the driver is changed to another driver, a new maximum regenerative braking allowance may be determined based on vehicle driving information during a predetermined time period after the change.

Furthermore, the maximum regenerative braking allowance is changed to a newly determined maximum regenerative braking allowance through an update process to be described later. Accordingly, the changed maximum regenerative braking allowance is used to control the regenerative braking of the vehicle.

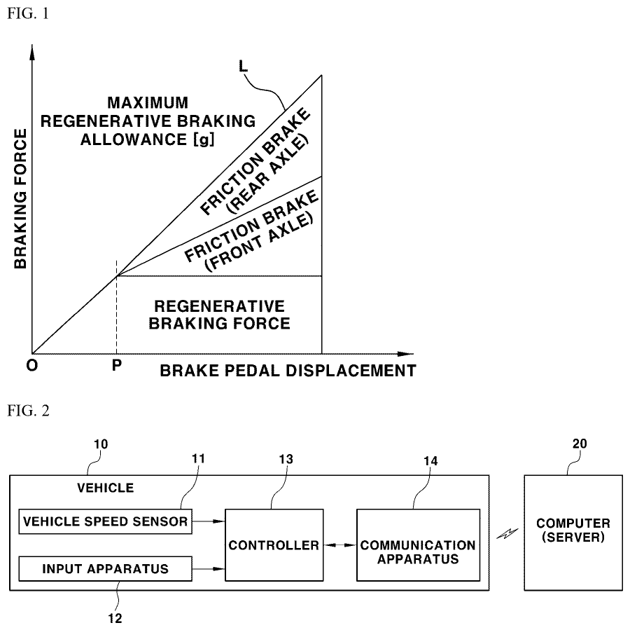

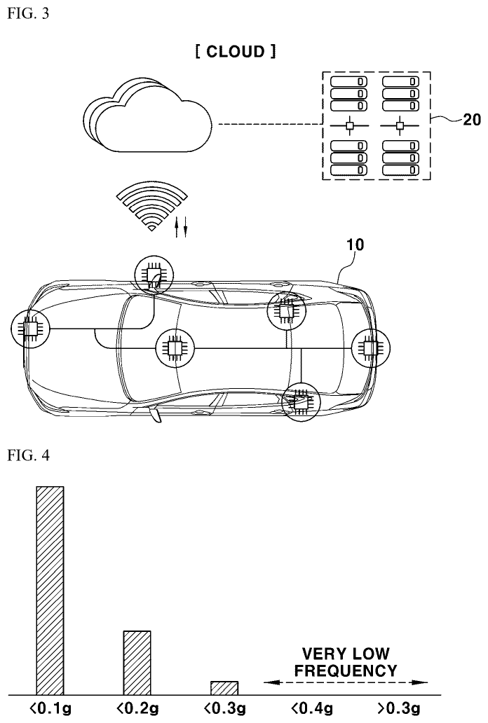

FIG. 2 is a diagram showing a configuration of a regenerative braking control system according to an exemplary embodiment of the present disclosure, and FIG. 3 is a diagram schematically showing a state in which Over-the-Air (OTA) update is performed in a vehicle according to an exemplary embodiment of the present disclosure.

As shown in FIGS. 2 and 3, a regenerative braking control system according to an exemplary embodiment of the present disclosure includes a vehicle speed sensor 11, a controller 13, and a communication apparatus 14, which are provided in a vehicle 10, and a computer 20 outside the vehicle.

The computer 20 is a device for communicating with the vehicle 10 for information transmission or reception in a wireless or wired manner, and allows the communication apparatus 14 to interconnect the computer 20 and the controller 13 for wireless or wired communication.

In a case where the wireless communication is used, the computer may be a server 20 outside the vehicle. In the following description, an example in which the computer 20 is the server 20 configured for performing wireless communication with the controller 13 through the communication apparatus 14 of the vehicle 10 will be described.

In an exemplary embodiment of the present disclosure, the server 20 outside the vehicle is configured to determine a new maximum regenerative braking allowance in which actual driver's driving tendency and pattern are considered based on the date on the vehicle speed for a specific time period transmitted from the vehicle 10.

Here, the server 20 analyzes a driver's vehicle speed pattern based on the date of the vehicle speed to determine an energy efficiency according to a change in the maximum regenerative braking allowance, and is configured to determine the maximum regenerative braking allowance in which the driver's vehicle speed pattern is considered based on information on the determined energy efficiency according to the change in the maximum regenerative braking allowance.

The server 20 transmits the new maximum regenerative braking allowance to the vehicle 10, and then, the vehicle 10 receives the new maximum regenerative braking allowance transmitted from the server 20 via the communication apparatus 14.

Accordingly, the controller 13 of the vehicle 10 updates the maximum regenerative braking allowance with the new maximum regenerative braking allowance received through the communication apparatus 14 instead of the existing value, and accordingly, the controller 13 of the vehicle 10 is configured to control the regenerative braking of the vehicle using the updated new maximum regenerative braking allowance.

In an exemplary embodiment of the present disclosure, the server 20 outside the vehicle may be a server in a telematics system that provides telematics services through a network, or a cloud server configured to store data and execute applications through the Internet and perform tasks in a virtualized environment.

In an exemplary embodiment of the present disclosure, the specific time period may be a predetermined cycle, and may be a predetermined OTA period between the vehicle 10 and the server. As is well known, Over-the-Air (OTA) refers to a technology that can update software in real time through wireless communication.

In recent vehicles, OTA is used to update vehicle software to add new functions, improve functions, and improve errors without appointment, USB connection, or the like.

In an exemplary embodiment of the present disclosure, a specific OTA update cycle may be set to update only the maximum regenerative braking allowance, and the maximum regenerative braking allowance of the controller 13 in the vehicle may be updated to the latest value using OTA.

Alternatively, in a process of updating other software using OTA between the server 20 and the vehicle 10, the maximum regenerative braking allowance may also be transmitted to the vehicle 10 to be updated.

In an exemplary embodiment of the present disclosure, the update of the maximum regenerative braking allowance may be performed periodically at a predetermined cycle (e.g., one month), or may be performed irregularly.

In both cases, the maximum regenerative braking allowance is newly determined by the server 20 using data such as a vehicle speed of the vehicle 10 collected from the last update to the next update (or just before the next update), and the newly determined maximum regenerative braking allowance is transmitted to the vehicle 10 at the next update.

In the present way, as the server 20 determines the maximum regenerative braking allowance using the data for the period after the immediately preceding update (update cycle), the latest maximum regenerative braking allowance is transmitted to the vehicle 10 at a transmission time based on a certain cycle or at a transmission time determined as necessary, so that the maximum regenerative braking allowance may be updated to the transmitted latest value. Thus, the updated maximum regenerative braking allowance may be used in the regenerative braking control including the braking force distribution process in the controller 13 of the vehicle 10.

The vehicle speed sensor 11 is a sensor which is configured to detect vehicle speed information necessary to update the maximum regenerative braking allowance, and a wheel speed sensor may be used as such a vehicle speed sensor. Furthermore, the vehicle driving information that the server 20 receives from the vehicle 10 may include the vehicle speed.

That is, the vehicle speed may be transmitted to the server 20 from the vehicle 10, and the vehicle speed detected through the vehicle speed sensor 11 in the vehicle 10 may be transmitted to the server 20 through the communication apparatus 14. Here, the controller 13 of the vehicle 10 may receive a signal of the vehicle speed sensor 11 through the vehicle network to obtain the vehicle speed information, and may transmit the result to the server 20 in real time.

Furthermore, the vehicle 10 wirelessly transmits the vehicle speed information to the server 20 at a predetermined sampling cycle (sampling rate), and the server 20 receives and stores the date of the vehicle speed received from the vehicle 10 during the period after the immediately preceding update and then newly determines the maximum regenerative braking allowance using the stored the date on the vehicle speed.

In the present way, the server 20 is configured to determine the maximum regenerative braking allowance based on the vehicle speed using the date of the vehicle speed collected during the period after the immediately preceding update from the vehicle 10, and then transmits the result to the vehicle.

Here, the server 20 analyzes a vehicle speed pattern of the vehicle 10 in which the driver's driving experience during the above-mentioned period is considered to determine an energy efficiency (Y) for each maximum regenerative braking allowance, and analyzes a change in the energy efficiency for each maximum regenerative braking allowance to determine a final maximum regenerative braking allowance.

In more detail, the server 20 is configured to determine a recovery energy in a deceleration section by changing the maximum regenerative braking allowance based on the date of the vehicle speed collected during the period after the immediately preceding update from the vehicle 10, obtains information on the energy efficiency defined as a function of the maximum regenerative braking allowance using the determined recovery energy and electrical energy consumption during vehicle driving, and then, is configured to determine the maximum regenerative braking allowance in a case where the energy efficiency during the above-mentioned period converges on an arbitrary value from the obtained energy efficiency information as the final maximum regenerative braking allowance of the vehicle.

The information on the energy efficiency defined as the function of the maximum regenerative braking allowance, that is, the energy efficiency corresponding to the maximum regenerative braking allowance, is an estimated energy efficiency, which may be an energy efficiency in which the driver's driving pattern, a vehicle speed pattern is considered.

Therefore, the final maximum regenerative braking allowance obtained by analyzing the estimated energy efficiency for each maximum regenerative braking allowance is the maximum regenerative braking allowance based on the vehicle speed in which the driver's driving experience is considered.

The above-mentioned period may be a period from the time of the immediately preceding update to the time of the next update (corresponding to the update cycle), and the recovered energy and the electrical energy consumption correspond to summed energy during the period. Furthermore, the electrical energy consumption is an electrical energy consumption by the vehicle during acceleration and constant speed driving.

The regenerative braking control system according to the exemplary embodiment of the present disclosure may further include the input apparatus 12 for resetting the updated maximum regenerative braking allowance in the vehicle 10 to the value at the time of vehicle delivery.

In a case where the driver of the vehicle whose maximum regenerative braking allowance has been updated during vehicle operation is changed to a new driver, for example, through used vehicle sales, the maximum regenerative braking allowance of the vehicle is in a personalized state based on the previous driver through update.

In other words, the maximum regenerative braking allowance customized in the previous driver's driving pattern (including vehicle speed pattern or the like) has already been set in the vehicle. Thus, the maximum regenerative braking allowance of the previous driver may not be suitable for a new driver's driving pattern. As a result, problems such as lowering of the energy efficiency and deterioration of the endurance of the PE system and rust may occur again.

Therefore, in a case where the driver of the vehicle is changed, the input apparatus 12 is provided so that the new driver can reset the updated maximum regenerative braking allowance to the value at the time of vehicle delivery.

The input apparatus 12 is connected to the controller 13 so that the controller 13 can recognize an operation state of the input apparatus 12, and may be an input apparatus such as a button or a switch provided in the vehicle, an input apparatus of an Audio, Video and Navigation (AVN) system, a touchscreen, or the like.

In a case where the input apparatus 12 is reset by a new driver, the controller 13 changes the maximum regenerative braking allowance that has been updated and stored to the initial value at the time of vehicle delivery.

Accordingly, the server 20 collects new driver's the date on the vehicle speed from the vehicle 10 until the next update, analyzes the vehicle speed pattern in which the new driver's driving experience is considered to determine a new maximum regenerative braking allowance, and transmits the result to the vehicle 10 so that the existing maximum regenerative braking allowance is updated to the new value.

Furthermore, the server 20 repeats the above-mentioned update through communication with the vehicle 10 so that the maximum regenerative braking allowance suitable for the new driver may be reset in the controller 13 of the vehicle 10, and the updated latest value may be used to control the regenerative braking of the vehicle.

During the regenerative braking of the vehicle, in a case where the driver's desired braking force is equal to or smaller than the updated maximum regenerative braking allowance, the driver's desired braking force may be met only by the regenerative braking force, but in a case where the driver's desired braking force is greater than the maximum regenerative braking allowance, since the regenerative braking force is limited to the maximum regenerative braking allowance, braking distribution is performed (see FIG. 1) to divide the driver's desired braking force into the maximum regenerative braking allowance and the friction braking force.

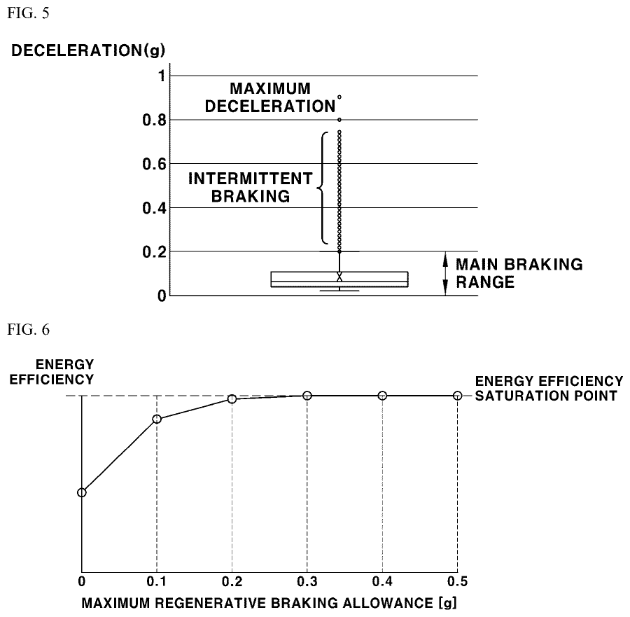

FIGS. 4 to 6 are diagrams showing a statistical analysis result of deceleration according to a driver's driving pattern and an energy efficiency trend according to a maximum regenerative braking allowance in an exemplary embodiment of the present disclosure. FIG. 4 shows the frequency of use of deceleration of a specific driver, in which the frequency of use of deceleration of approximately 0.2 g or less is very high, and the frequency of use of deceleration of 0.3 g or greater is very low. FIG. 5 shows that a main braking range of the specific driver is less than or equal to 0.2 g, and FIG. 6 shows that the energy efficiency converges on a specific value from the deceleration of 0.2 g or greater.

According to the exemplary embodiment, the vehicle speed pattern in which the driver's driving experience is considered during the period between the previous update and the next update is analyzed, the estimated energy efficiency for each maximum regenerative braking allowance is determined, an energy efficiency saturation point at which the energy efficiency converges on a specific value as shown in FIG. 6 is determined, and then, the maximum regenerative braking allowance that corresponds to the above-mentioned energy efficiency saturation point is determined as a new value.

Accordingly, the maximum regenerative braking allowance of the vehicle is updated to the new value so that customized regenerative braking control for each vehicle/driver may be performed, and thus, it is possible to maximize the energy efficiency and improve the above-mentioned problems through continuous updates.

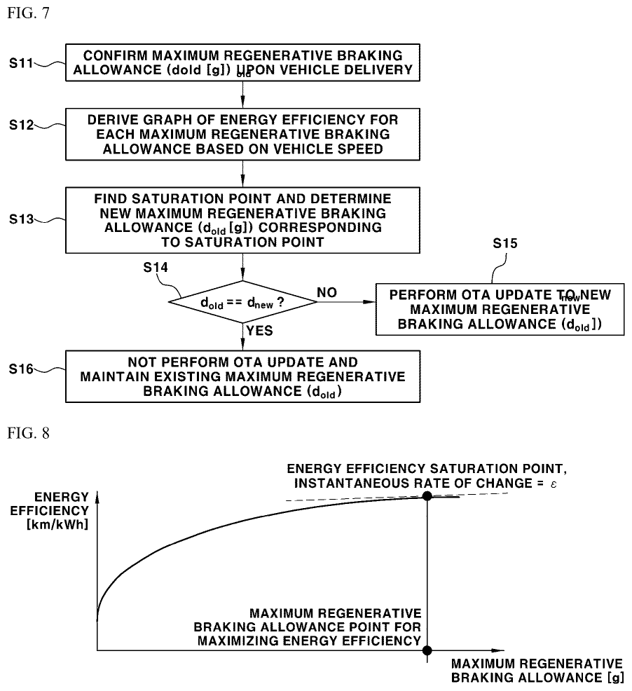

FIG. 7 is a flowchart showing a process of updating a maximum regenerative braking allowance in a regenerative braking control method according to an exemplary embodiment of the present disclosure, and shows a process of performing a first OTA update in a state in which an initial value of a maximum regenerative braking allowance at the time of vehicle delivery is stored in a vehicle.

In FIG. 7, ‘d_{old} [g]’ represents an initial value of a maximum regenerative braking allowance at the time of vehicle delivery, which is defined as a current maximum regenerative braking allowance based on the immediately preceding update, including the initial value of the maximum regenerative braking allowance in an exemplary embodiment of the present disclosure.

In an exemplary embodiment of the present disclosure, as shown in FIG. 7, after the first OTA update is performed, the OTA update may be performed continuously in the same manner, and through the repeated OTA update, the maximum regenerative braking allowance may be reset to a value in which the driver's driving pattern is considered.

The regenerative braking control method according to the exemplary embodiment includes a process of updating the maximum regenerative braking allowance of the vehicle. Furthermore, the regenerative braking control method according to the exemplary embodiment of the present disclosure may further include a process of performing regenerative braking of the vehicle using the updated regenerative braking maximum allowance. As shown in FIG. 7, in a state in which the vehicle stores the maximum regenerative braking allowance at the time of vehicle delivery (S11), the server 20 derives a graph of the energy efficiency for each maximum regenerative braking allowance based on the date of the vehicle speed of the vehicle, during subsequent vehicle driving (S12).

To the present end, the controller 13 obtains information on the vehicle speed from a signal of the vehicle speed sensor 110, and the obtained vehicle speed information is transmitted from the vehicle 10 to the server 20. Here, the date of the vehicle speed obtained at a predetermined sampling cycle in the vehicle 10 may be transmitted in real time to the server 20.

The server 20 determines a graph of the energy efficiency for the maximum regenerative braking allowance using the date of the vehicle speed received from the vehicle 10. The process of deriving the graph representing the energy efficiency for the maximum regenerative braking allowance is as follows.

First, the server 20 is configured to determine an energy consumption during vehicle driving using the date of the vehicle speed. Here, the energy consumption (E_{acc_i}) between a previous sampling point (tᵢ₋₁) and the next (may be present) sampling point (tᵢ) during acceleration and constant speed driving may be determined by the following Equation 1.

$${E}_{acc \_ i} = [ {f}_{0} + {f}_{1} \times ( \frac{{v}_{i - 1} + {v}_{i}}{2} ) + {f}_{2} \times \frac{{( {v}_{i - 1} + {v}_{i} )}^{2}}{4} + 1.03 {Ma}_{i} ] {s}_{i} \qquad [ Equation 1 ]$$

Here, f₀, f₁, and f₂ represent driving resistances of the vehicle, which are values corresponding to a vehicle type and may be stored in advance in the server 20. Alternatively, the driving resistances may be transmitted from the vehicle together with the vehicle speed. Furthermore, vᵢ₋₁ represents a vehicle speed at the previous sampling point (tᵢ₋₁), vᵢ represents a vehicle speed at the next (which may be current) sampling point (tᵢ), and M represents a vehicle weight.

The vehicle weight may be a value stored in advance in the server 20 for each vehicle type, or may be a value transmitted from the vehicle 10 together with the vehicle speed. Since the vehicle weight depends on the number of passengers, loaded cargo, or the like, an actual weight value which is estimated in real time by a weight estimation logic based on vehicle driving information by the controller 13 and is transmitted to the server 20 may be used to determine the energy consumption.

Various known methods for estimating the vehicle weight in real time based on information collected from the vehicle may be used in an exemplary embodiment of the present disclosure. Detailed description of the known vehicle weight estimation methods will be omitted.

In Equation 1, aⱼ represents a vehicle acceleration between the previous sampling point (tᵢ₋₁) and the next (which may be current) sampling point (tᵢ) during acceleration and constant speed driving, which may be a derivative of the vehicle speed. Furthermore, sᵢ represents a vehicle travel distance between the previous sampling point (tᵢ₋₁) and the next (which may be current) sampling point (tᵢ), which may be an integral value of the vehicle speed.

In a case where the energy consumption (E_{acc_i}) determined by Equation 1 is an instantaneous energy consumption during a sampling cycle, the energy consumption during the entire period (the period between t_{end} and tₛₜₐᵣₜ) may be determined by Equation 2.

$${E}_{total \_ cycle} = {\sum }_{{t}_{start}}^{{t}_{end}} {E}_{acc \_ i} \qquad [ Equation 2 ]$$

Here, E_{total_cycle} represents a total energy consumption during an update cycle, that is, a period between the immediately preceding update and the next update. As shown in Equation 2, the total energy consumption during the entire period (E_{total_cycle}) may be obtained by summing the instantaneous energy consumption (E_{acc_i}) determined by Equation 1.

In Equation 2, tₛₜₐᵣₜ represents a start point of the determination of the energy efficiency after the immediately preceding update. Furthermore, t_{end} represents a last point of the determination of the energy efficiency just before the next update. In a case where the maximum regenerative braking allowance is updated for the first time after vehicle delivery, tₛₜₐᵣₜ may be a point of time of the vehicle delivery.

Accordingly, the server 20 is configured to determine the recovery energy (E_{acc_i}) between the previous sampling point (tᵢ₋₁) and the next sampling point (tᵢ) during the same deceleration time period, which may be determined by the following Equation 3 and Equation 4.

$$for {d}_{i} \leq {d}_{limit} , \qquad [ Equation 3 ]$$

$${E}_{reg \_ i} = [ {f}_{0} + {f}_{1} \times ( \frac{{v}_{i - 1} + {v}_{i}}{2} ) + {f}_{2} \times \frac{{( {v}_{i - 1} + {v}_{i} )}^{2}}{4} + 1.03 {Md}_{i} ] {s}_{i}$$

$$for {d}_{i} > {d}_{limit} , \qquad [ Equation 4 ]$$

$${E}_{reg \_ i} = [ {f}_{0} + {f}_{1} \times ( \frac{{v}_{i - 1} + {v}_{i}}{2} ) + {f}_{2} \times \frac{{( {v}_{i - 1} + {v}_{i} )}^{2}}{4} + 1.03 {Md}_{limit} ] {s}_{i}$$

In Equations 3 and 4, dᵢ represents an actual vehicle deceleration between the previous sampling point (tᵢ₋₁) and the next sampling point (tᵢ) during deceleration, which may be a differential value of the vehicle speed.

In an exemplary embodiment of the present disclosure, the acceleration, the constant speed and the deceleration of the vehicle may be determined in real time by the server 20 from the date of the vehicle speed received from the vehicle 10.

Normally, a deceleration value has an opposite sign compared to an acceleration value. That is, in a case where the acceleration value of the vehicle is defined as a positive (+) value, the deceleration value is defined as a negative (−) value.

However, in Equations 3 and 4, the actual vehicle deceleration (dᵢ) value is defined as a positive (+) value, and the actual vehicle deceleration dᵢ may be defined as an absolute value of the actual vehicle deceleration.

Furthermore, dₗᵢₘᵢₜ represents a maximum regenerative braking allowance, which may be defined as a positive (+) value as in the actual vehicle deceleration value dᵢ in Equations 3 and 4. Furthermore, in Equations 3 and 4, the actual vehicle deceleration and the maximum regenerative braking allowance may be expressed in units of g (gravitational acceleration).

In an exemplary embodiment of the present disclosure, the server 20 is configured to determine the recovery energy for each maximum regenerative braking allowance using Equations 3 and 4 while changing the maximum regenerative braking allowance at a certain interval using Equations 3 and 4. Here, the changed maximum regenerative braking allowance may be coordinate values on horizontal axis of an energy efficiency graph shown in FIG. 8, which will be described later.

As shown in Equation 3, in a case where the absolute value (dᵢ) of the actual vehicle deceleration is less than or equal to the maximum regenerative braking allowance (dₗᵢₘᵢₜ) (dᵢ≤dₗᵢₘᵢₜ), in determining the recovery energy (E_{reg_i}), Equation 3 is used, and the absolute value (dᵢ) of the actual vehicle deceleration is used as the deceleration value.

On the other hand, in a case where the absolute value (dᵢ) of the actual vehicle deceleration is greater than the maximum regenerative braking allowance (dᵢ>dₗᵢₘᵢₜ), through regenerative braking, the energy is recovered only corresponding to the deceleration limited by the maximum regenerative braking allowance (dₗᵢₘᵢₜ) (the deceleration is limited to the maximum regenerative braking allowance). In the instant case, in determining the recovery energy (E_{reg_i}), Equation 4 is used, and the maximum regenerative braking allowance (dₗᵢₘᵢₜ) is used as the deceleration value.

In a case where the recovery energy (E_{reg_i}) determined by Equations 3 and 4 is an instantaneous energy consumption during the sampling cycle, the recovery energy (E_{regen_Cycle}) during the entire period of the update cycle (the period between t_{end} and tₛₜₐᵣₜ) may be determined by Equation 5.

$${E}_{regen \_ Cycle} = {\sum }_{{t}_{start}}^{{t}_{end}} {E}_{reg \_ i} \qquad [ Equation 5 ]$$

Here, E_{regen_Cycle} represents recovery energy in a deceleration section during the same period as in the energy consumption (E_{total_cycle}), and may be the total recovery energy during the update cycle, that is, the time between the immediately preceding update and the next update.

As shown in Equation 5, the total energy consumption during the entire period (E_{regen_Cycle}) may be obtained by summing the instantaneous recovery energy (E_{reg_i}) determined by Equations 3 and 4.

In a process of determining the total recovery energy, the instantaneous recovery energy for each maximum regenerative braking allowance is obtained by Equations 3 and 4, and the total recovery energy for each maximum regenerative braking allowance may be obtained by Equation 5.

As described above, after the recovery energy (E_{total_cycle}) and the energy consumption (E_{regen_Cycle}) for the entire period are obtained, the energy efficiency (γ) for each maximum regenerative braking allowance may be obtained by Equation 6.

$$γ = {\sum }_{{t}_{start}}^{{t}_{end}} {s}_{i} / ( {E}_{total \_ cycle} + {E}_{regen \_ cycle} ) \qquad [ Equation 6 ]$$

As may be seen from Equation 6, the energy efficiency (Y) may be determined as total travel distance/(total energy consumption+total recovery energy), which may be obtained by a function with the maximum regenerative braking allowance as a variable. A graph shown in FIG. 8 may be derived from the energy efficiency obtained by the function of the maximum regenerative braking allowance.

In Equation 6, the total travel distance is the sum of the instantaneous travel distance (sᵢ) of the vehicle obtained from the date of the vehicle speed during the entire period (the period between t_{end} and tₛₜₐᵣₜ).

As described above, in an exemplary embodiment of the present disclosure, the energy efficiency determined only according to the vehicle speed pattern is determined, instead of an energy efficiency affected by an air conditioning load, an electric field load, and the like. In other words, the vehicle speed-based energy efficiency in which the air conditioning load and the electric field load are not considered is determined. It is difficult to estimate the impact of regenerative braking by an instantaneous energy efficiency displayed on a cluster of the vehicle.

After the graph of the energy efficiency for each maximum regenerative braking allowance is determined as described above, as shown in FIG. 7, an energy efficiency saturation point is found from the determined energy efficiency information to determine the maximum regenerative braking allowance corresponding to the energy efficiency saturation point, and accordingly, the determined maximum regenerative braking allowance is determined as a new maximum regenerative braking allowance (d_{new}).

FIG. 8 is a diagram showing energy efficiency based on a maximum regenerative braking allowance according to an exemplary embodiment of the present disclosure, and shows a graph of the energy efficiency for each maximum regenerative braking allowance. Here, a horizontal axis represents a maximum regenerative braking allowance ([g]), and a vertical axis represents energy efficiency ([km/kWh]).

In a case where the graph of energy efficiency for each maximum regenerative braking allowance is determined as described above, an energy efficiency saturation point at which the energy efficiency converges on a specific value is determined, and a maximum regenerative braking allowance corresponding to the energy efficiency saturation point is determined as a new maximum regenerative braking allowance (d_{new}) which is newly updated (S13).

As the maximum regenerative braking allowance increases, the energy efficiency may also increase. Referring to FIG. 8, the larger the maximum regenerative braking allowance in the energy efficiency graph, the greater the corresponding increase in energy efficiency.

Furthermore, as the maximum regenerative braking allowance increases, the energy efficiency converges on a specific value. The point at which the energy efficiency converges on the specific value in the graph is defined as the energy efficiency saturation point, and an instantaneous change rate at a section where the energy efficiency no longer changes in the graph will be zero.

Referring to FIG. 8, as the maximum regenerative braking allowance increases, it may be seen that the instantaneous change rate (rate of energy efficiency change) at the point in the graph that represents the corresponding energy efficiency gradually decreases.

In an exemplary embodiment of the present disclosure, during the search for the energy efficiency saturation point, the server 20 may be configured to determine that the point in the energy efficiency graph in which the instantaneous change rate becomes a preset value (¿) is the energy efficiency saturation point.

Here, the preset value may be set to a very small value close to 0, which may be determined in consideration of an allowable spread range such as the energy efficiency for each vehicle type or all electric range (AER).

In a case where the energy efficiency saturation point on the graph is set as described above, the maximum regenerative braking allowance corresponding to the energy efficiency saturation point may be determined as a new maximum regenerative braking allowance (d_{new}). The determined value corresponds to the maximum regenerative braking allowance in which the energy efficiency is maximized.

Accordingly, as shown in FIG. 7, the server 20 compares the newly determined maximum regenerative braking allowance (d_{new}) with the current regenerative braking maximum allowance (d_{old}) (S14), and maintains the vehicle's existing maximum regenerative braking allowance without performing OTA update in a case where a difference between the two values is close to or equal to the set value (S16).

On the other hand, in a case where the newly determined maximum regenerative braking allowance (d_{new}) and the current maximum regenerative braking allowance (d_{old}) are different, the server 20 transmits the new maximum regenerative braking allowance to the vehicle 10, and is configured to perform OTA update to replace the existing value with the new value (S15).

Here, the server 20 may be configured to determine that the two values are different in a case where the difference between the new maximum regenerative braking allowance (d_{new}) and the current maximum regenerative braking allowance (d_{old}) is greater than the set value.

Hereinabove, the regenerative braking control system and method according to the exemplary embodiment of the present disclosure have been described, and the above-described regenerative braking control system and method may be applied to all vehicles which may be driven by a motor and regenerative braking, such as hybrid vehicles (HEV, PHEV), battery electric vehicles (BEV), fuel cell vehicles (FCEV), and extended range electric vehicles (EREV).

The process of determining the maximum regenerative braking allowance by the server 20 outside the vehicle, wirelessly transmitting the result to the vehicle 10, and updating the maximum regenerative braking allowance of the vehicle has been described. This may be applied only to vehicles that can perform wireless update using OTA, etc.

Here, the present disclosure further includes a process of storing and accumulating the date of the vehicle speed since the last update in the vehicle in a storage to use a wired update method instead of the wireless update method, and then transmitting, in a case where the computer 20 is connected by wire, the date of the vehicle speed from the vehicle 10 to the computer 20 through the communication apparatus 14.

Thus, the computer 20 may newly determine the maximum regenerative braking allowance in the same manner as in the server 20 using the date of the vehicle speed input from the vehicle 10.

Accordingly, the computer 20 transmits the new maximum regenerative braking allowance to the vehicle 10 in a wired manner to update the stored maximum regenerative braking allowance to the new value. Accordingly, in the vehicle 10, regenerative braking control is performed using the new maximum regenerative braking allowance updated while driving.

In the present way, in the case of vehicles in which the wireless update using OTA, etc. cannot be performed, the maximum regenerative braking allowance may be updated through periodic wired updates.

According to the regenerative braking control system and method of the present disclosure, it is possible to maximize an electric efficiency of the vehicle by updating a maximum regenerative braking allowance used for braking force distribution and regenerative braking control to a value based on a driver's actual driving pattern (vehicle speed pattern), and to solve problems such as deterioration of endurance of the power electric (PE) system or rust of the brake disc.

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

1. A system that controls regenerative braking, the system comprising:
a vehicle speed sensor detecting a vehicle speed of a vehicle;
a controller that controls the regenerative braking of the vehicle;
a communication apparatus that transmits data on the vehicle speed detected by the vehicle speed sensor; and
a computer that analyzes a driver's vehicle speed pattern based on the date of the vehicle speed transmitted through the communication apparatus to obtain information on an energy efficiency according to a change in a maximum regenerative braking allowance, determines the maximum regenerative braking allowance in which the driver's vehicle speed pattern is considered based on the obtained information on the energy efficiency according to the change in the maximum regenerative braking allowance, and transmits a result of the determining to the vehicle,
wherein the controller updates the maximum regenerative braking allowance for controlling the regenerative braking of the vehicle to the maximum regenerative braking allowance received from the computer.

2. The system of claim 1, wherein the computer finds an energy efficiency saturation point at which the energy efficiency converges on a specific value based on the information on the energy efficiency according to the change in the maximum regenerative braking allowance, and determines the maximum regenerative braking allowance corresponding to the energy efficiency saturation point as the maximum regenerative braking allowance in which the driver's vehicle speed pattern is considered.

3. The system of claim 1, wherein the computer is a server disposed outside the vehicle, the server being connected to the vehicle through the communication apparatus wirelessly.

4. The system of claim 1, wherein the computer is connected to the vehicle through the communication apparatus in a wired manner.

5. The system of claim 1, wherein the computer receives the date on the vehicle speed at a specific sampling cycle for a predetermined time period from the vehicle, newly determines the maximum regenerative braking allowance in which the driver's vehicle speed pattern is considered based on the date of the vehicle speed during the predetermined time period, and transmits the newly determined maximum regenerative braking allowance to the vehicle.

6. The system of claim 5, wherein the predetermined time period is set as an update cycle of the maximum regenerative braking allowance in the computer, and the computer repeats a process of determining the maximum regenerative braking allowance in which the driver's vehicle speed pattern is considered based on the date of the vehicle speed received from the vehicle during the update cycle, and transmits the newly determined maximum regenerative braking allowance to the vehicle at the update cycle.

7. The system of claim 5, wherein the computer determines a total energy consumption in an acceleration section and a constant speed driving section from the date of the vehicle speed during the predetermined time period, and a total recovery energy in a deceleration section for each maximum regenerative braking allowance, and determines the information on the energy efficiency according to the change in the maximum regenerative braking allowance using information on the total energy consumption and the total recovery energy, and a total travel distance determined from the date of the vehicle speed during the predetermined time period.

8. The system of claim 7, wherein the computer determines an instantaneous energy consumption from data on vehicle speeds, vehicle driving resistances, and vehicle weights at a previous sampling point and a next sampling point during acceleration and constant speed driving, and determines the total energy consumption by summing the instantaneous energy consumption during the predetermined time period.

9. The system of claim 7, wherein the computer determines an instantaneous recovery energy from data on vehicle speeds, decelerations obtained from the date of the vehicle speed, vehicle driving resistances, and vehicle weights at a previous sampling point and at a next sampling point during deceleration, and determines the total recovery energy by summing the instantaneous recovery energy during the predetermined time period.

10. The system of claim 9, wherein in determining the instantaneous recovery energy, the computer changes the maximum regenerative braking allowance and determines the instantaneous recovery energy for each maximum regenerative braking allowance by the regenerative braking using the changed maximum regenerative braking allowance,
determines, based on determining that the deceleration is equal to or lower than the changed maximum regenerative braking allowance, the instantaneous recovery energy for each maximum regenerative braking allowance using the deceleration,
determines, based on determining that the deceleration is greater than the changed maximum regenerative braking allowance, the instantaneous recovery energy for each maximum regenerative braking allowance using the maximum regenerative braking allowance instead of the deceleration, and
determines the total recovery energy for each maximum regenerative braking allowance by summing the instantaneous recovery energy determined using the deceleration during the predetermined time period and the instantaneous recovery energy determined using the maximum regenerative braking allowance during the predetermined time period.

11. The system of claim 1, further comprising:
an input apparatus which is operated in response to a driver's input to reset the updated maximum regenerative braking allowance to a preset initial value.

12. A method for controlling regenerative braking, the method comprising:
transmitting data on a vehicle speed detected by a vehicle speed sensor, by a communication apparatus;
obtaining information on an energy efficiency according to a change in a maximum regenerative braking allowance based on the date of the vehicle speed transmitted from a vehicle, by a computer connected to the vehicle through the communication apparatus;
determining a maximum regenerative braking allowance in which a driver's vehicle speed pattern is considered based on the obtained information on the energy efficiency according to the change in the maximum regenerative braking allowance, and transmitting the determined maximum regenerative braking allowance to the vehicle, by the computer; and
updating the maximum regenerative braking allowance for controlling the regenerative braking of the vehicle to the maximum regenerative braking allowance received from the computer, by a controller disposed in the vehicle.

13. The method of claim 12, further comprising:
controlling the regenerative braking of the vehicle using the updated maximum regenerative braking allowance, by the controller.

14. The method of claim 12,
wherein, in the determining of the maximum regenerative braking allowance in which the driver's vehicle speed pattern is considered, the computer finds an energy efficiency saturation point at which the energy efficiency converges on a specific value based on the information on the energy efficiency according to the change in the maximum regenerative braking allowance, and determines the maximum regenerative braking allowance corresponding to the energy efficiency saturation point as the maximum regenerative braking allowance in which the driver's vehicle speed pattern is considered.

15. The method of claim 12, wherein the computer receives the date on the vehicle speed at a specific sampling cycle for a predetermined time period from the vehicle, newly determines the maximum regenerative braking allowance in which the driver's vehicle speed pattern is considered based on the date of the vehicle speed during the predetermined time period, and transmits the newly determined maximum regenerative braking allowance to the vehicle.

16. The method of claim 15, wherein the predetermined time period is set as an update cycle of the maximum regenerative braking allowance in the computer, and the computer repeats a process of determining the maximum regenerative braking allowance in which the driver's vehicle speed pattern is considered based on the date of the vehicle speed received from the vehicle during the update cycle, and transmits the newly determined maximum regenerative braking allowance to the vehicle at the update cycle.

17. The method of claim 15, wherein the computer determines a total energy consumption in an acceleration section and a constant speed driving section from the date of the vehicle speed during the predetermined time period, and a total recovery energy in a deceleration section for each maximum regenerative braking allowance, and determines the information on the energy efficiency according to the change in the maximum regenerative braking allowance using information on the total energy consumption and the total recovery energy, and a total travel distance determined from the date of the vehicle speed during the predetermined time period.

18. The method of claim 17, wherein the computer determines an instantaneous energy consumption from data on vehicle speeds, vehicle driving resistances, and vehicle weights at a previous sampling point and a next sampling point during acceleration and constant speed driving, and determines the total energy consumption by summing the instantaneous energy consumption during the predetermined time period.

19. The method of claim 17, wherein the computer determines an instantaneous recovery energy from data on vehicle speeds, decelerations obtained from the date of the vehicle speed, vehicle driving resistances, and vehicle weights at a previous sampling point and at a next sampling point during deceleration, and determines the total recovery energy by summing the instantaneous recovery energy during the predetermined time period.

20. The method of claim 19, wherein in determining the instantaneous recovery energy, the computer changes the maximum regenerative braking allowance and determines the instantaneous recovery energy for each maximum regenerative braking allowance by the regenerative braking using the changed maximum regenerative braking allowance,
determines, based on determining that the deceleration is equal to or lower than the changed maximum regenerative braking allowance, the instantaneous recovery energy for each maximum regenerative braking allowance using the deceleration,
determines, based on determining that the deceleration is greater than the changed maximum regenerative braking allowance, the instantaneous recovery energy for each maximum regenerative braking allowance using the maximum regenerative braking allowance instead of the deceleration, and
determines the total recovery energy for each maximum regenerative braking allowance by summing the instantaneous recovery energy determined using the deceleration during the predetermined time period and the instantaneous recovery energy determined using the maximum regenerative braking allowance during the predetermined time period.
